(19) United States
(12) Patent Application Publication
(10) Pub. No.: US 2021/0087934 A1
(43) Pub. Date: Mar. 25, 2021

(54) ROTOR BALANCING WEIGHT

(71) Applicant: PRATT & WHITNEY CANADA CORP., Longueuil (CA)

(72) Inventors: Thomas VEITCH, Toronto (CA); Richard IVAKITCH, Scarborough (CA); Bernard CHOW, Mississauga (CA)

(21) Appl. No.: 16/575,935

(22) Filed: Sep. 19, 2019

(51) Int. Cl. F01D 5/02; F04D 29/66; F16F 15/32

(52) U.S. Cl. CPC F01D 5/027; F05D 2220/32; F16F 15/32; F04D 29/662

(57) ABSTRACT

A balancing weight is disclosed. The balancing weight is engageable in a hole defined in a rotor, the hole having a predetermined cross-sectional dimension. The balancing weight comprises: a head having a predetermined weight, and a shank extending axially from the head. The shank includes at least two portions expandable in a direction transverse to a hole engagement direction between a first position in which a cross-sectional dimension of the shank is less than the predetermined cross-sectional dimension of the hole and a second position in which the cross-sectional dimension of the shank is greater than the predetermined cross-sectional dimension of the hole in the rotor. A method for installing a balancing weight to an engine rotor is also disclosed.

### TECHNICAL FIELD

The application relates generally to rotors, and more particularly, to rotor balancing.

### BACKGROUND OF THE ART

A rotor assembly of a gas turbine engine may require balancing, for example, by addition of balancing weights in selected locations of the rotor assembly. Balancing weights are conventionally provided through dedicated attachments points on the rotor. Installation and/or disassembly of conventional balancing weights may require access to areas of the rotor through limited spaces, which may render installation and/or disassembly complex and/or tedious.

### SUMMARY

In one aspect, there is provided a balancing weight engageable in a hole defined in a rotor, the hole having a predetermined cross-sectional dimension, the balancing weight comprising: a head having a predetermined weight, and a shank extending axially from the head, the shank including at least two portions expandable in a direction transverse to a hole engagement direction between a first position in which a cross-sectional dimension of the shank is less than the predetermined cross-sectional dimension of the hole and a second position in which the cross-sectional dimension of the shank is greater than the predetermined cross-sectional dimension of the hole in the rotor.

In another aspect, there is provided a rotor assembly of a gas turbine engine, the rotor assembly comprising: a rotor mounted to the gas turbine engine for rotation about a rotation axis, the rotor having a wall and defining at least one hole through said wall, the at least one hole having a predetermined cross-sectional dimension; and a balancing weight engaged through the hole, the balancing weight removably secured to the rotor through engagement into the hole, the balancing weight including: a head having a predetermined weight; a shank extending axially from the head, the shank having at least two portions expandable in a direction transverse to a hole engagement direction between a first position in which a cross-sectional dimension of the shank is less than the predetermined cross-sectional dimension of the hole and a second position in which the cross-sectional dimension of the shank is greater than the predetermined cross-sectional dimension of the hole in the rotor.

In a further aspect, there is provided a method for installing a balancing weight on a rotor, the rotor defining a wall, a hole defined in the wall, the balancing weight including a head having a predetermined weight and a shank extending axially from the head, the method comprising: inserting the shank of the balancing weight in the hole in the wall, and radially expanding the shank in the hole until the shank adopts a self-retaining state, the cross-sectional dimension of the shank in the self-retaining state being greater than the cross-sectional dimension of the hole.

In yet another aspect, there is provided a method for engaging a balancing weight in a hole defined in an engine rotor, the hole having a cross-sectional dimension, the balancing weight having a head having a predetermined weight and a shank extending axially from the head, the method comprising: inserting the shank through an opening of the hole; driving the shank in the hole to a first axial position, including contracting the shank, thereby reducing a cross-sectional dimension of the shank in a compressed state, the cross-sectional dimension of the shank in the compressed state being smaller than the cross-sectional dimension of the hole opening; and driving further the shank in the hole from the first axial position to a second axial position, wherein in the second axial position the cross-sectional dimension of the shank increases to a dimension larger than the cross-sectional dimension of the hole opening.

### DESCRIPTION OF THE DRAWINGS

Reference is now made to the accompanying figures in which:

FIG. 1 is a schematic cross-sectional view of a gas turbine engine;

FIG. 2 is a cross-sectional partial view of an exemplary rotor assembly such as in the engine of FIG. 1;

FIG. 3 is a lateral view of an exemplary balancing weight engageable to a rotor of a rotor assembly as in FIG. 2;

FIG. 3A illustrates a cross-section of the shank of the balancing weight in FIG. 3;

FIG. 4 is another lateral view of the exemplary balancing weight of FIG. 3, shown from a different angle;

FIG. 5 is a magnified view of the rotor assembly shown in FIG. 2, showing a cross-section of the rotor and a balancing weight as in FIG. 3 installed thereto;

FIG. 6 is a cross-sectional lateral view of another exemplary balancing weight engageable to a rotor of a rotor assembly as in FIG. 2;

FIG. 7 is a cross-sectional lateral view of another exemplary balancing weight engageable to a rotor of a rotor assembly as in FIG. 2;

FIG. 8 is a cross-sectional lateral view of yet another exemplary balancing weight engageable to a rotor of a rotor assembly as in FIG. 2;

FIG. 9 is a cross-sectional lateral view of a further exemplary balancing weight engageable to a rotor of a rotor assembly as in FIG. 2; and

FIG. 10 is a cross-sectional lateral view of another exemplary balancing weight engageable to a rotor of a rotor assembly as in FIG. 2.

### DETAILED DESCRIPTION

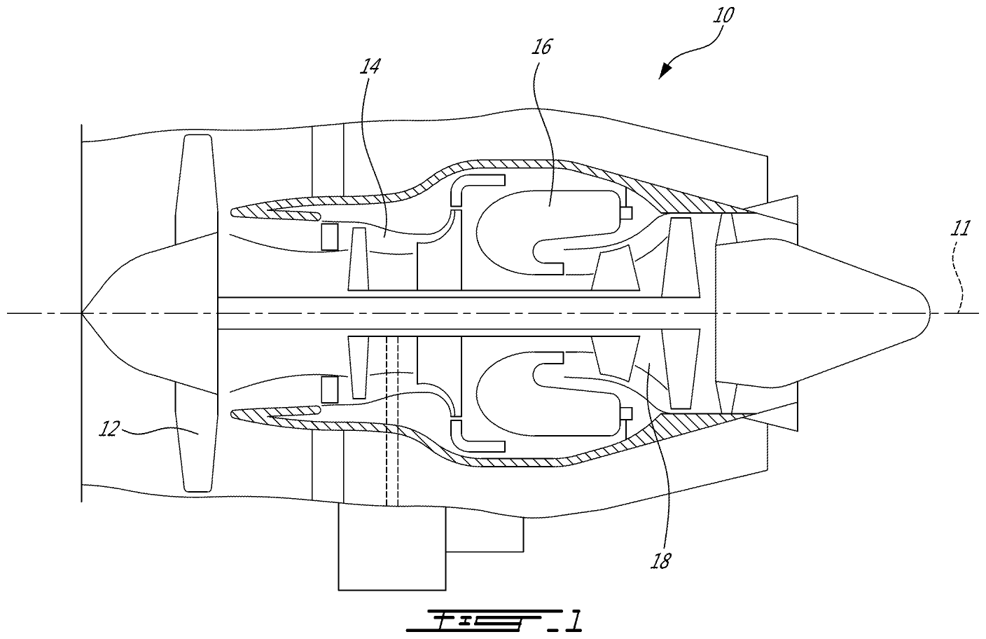

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

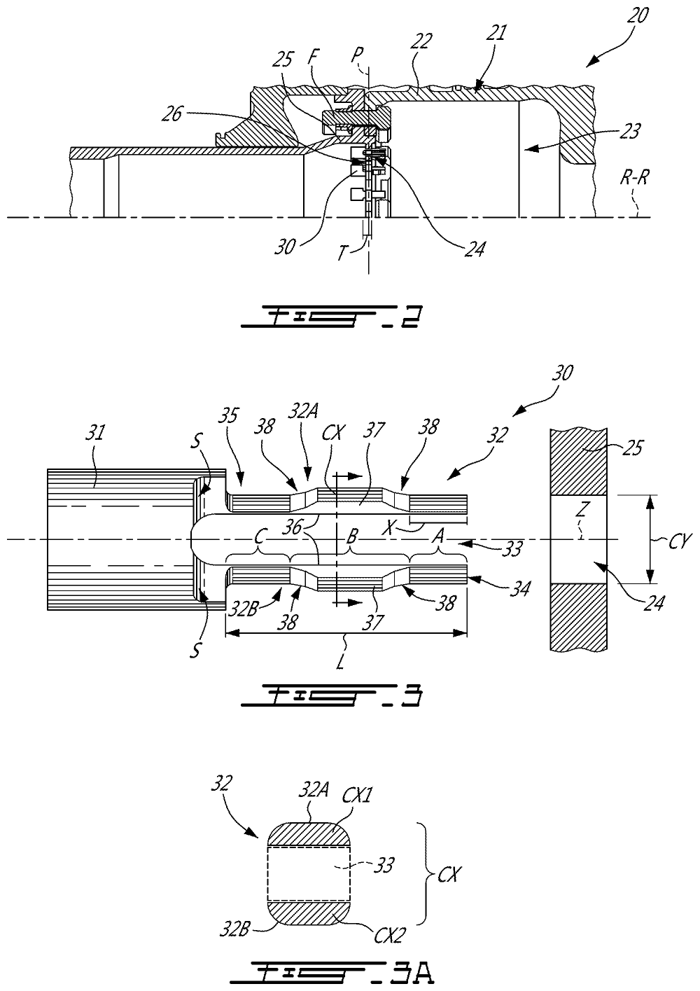

FIG. 2 shows, in cross-section, a rotor assembly 20, which may be a rotor assembly 20 of the compressor section (or simply a compressor assembly), or a rotor assembly from another section of the engine 10, such as the turbine section 18 of the engine 10. The rotor assembly 20 may include a rotor 21 including a shaft 22 with blades (not shown) having a disc (not shown) connected thereto or made as an integral part thereof. The rotor 21 is mounted to the gas turbine engine 10 for rotation about a rotation axis R-R. The rotor 21 may be made of one elongated shaft, or a plurality of separate rotor portions in axial series with each other and connected together, such as via fasteners. In the depicted embodiment, the rotor assembly 20 has a bore 23, i.e. the rotor 21 is hollowed such that gas may flow therein. The bore 23 may have sections of different internal radial dimensions (radial dimension or simply bore size), such as to define chambers or bore sections. In the depicted embodiments, balancing weights 30 are removably secured to the rotor 21 within the bore 23 of the rotor 21.

The rotor 21 has holes 24 for engagement of the balancing weights 30 to the rotor 21. The number of holes 24 may vary depending on the embodiments. In other words, the rotor 21 has at least one hole 24 for engagement of a balancing weight 30 to the rotor 21. In the embodiment shown, the holes 24 are defined through a wall 25 of the rotor 21. As shown in FIG. 2, the wall 25 of the rotor 21 is in the form of a flange 26 depending inwardly from the rotor annular body. In other words, the rotor 21 defines a flange 26 extending within the bore 23 of the rotor 21.

In the depicted embodiment, the wall 25 has two opposite sides, such as for a disc, with a thickness T, and the holes 24 are defined through the wall 25 from one side of the wall 25 to the other. While the holes 24 are shown as extending along the thickness T, i.e. normal to the axial plane P of the wall 25, the orientation of the holes 24 may be different in other embodiments.

In the embodiment shown, the flange 26 is located at an end of a rotor portion, adjacent a junction between adjacent rotor portions. Other locations are possible in other embodiments. In other words, the balancing weight(s) 30 may engage the rotor 21 through hole(s) 24 in a wall 25 (or flange 26) of the rotor 21 located at a further distance from the junction between adjacent rotor portions. In the depicted embodiment, the two rotor portions are connected together via fasteners F. Although the balancing weights 30 may share similarities, such as a general appearance, with fasteners F that connect rotor portions together, the balancing weights 30 are different functionally, and structurally, as will be discussed later.

The holes 24 have a predetermined cross-sectional dimension to receive a balancing weight 30. The cross-sectional dimension of the holes 24 may have different size and/or shape depending on the embodiments. For instance, the cross-sectional dimension may be circular, square, although other shapes may be contemplated. The cross-sectional dimension may have a standard hole size and/or geometry, for instance according to metric or imperial standards, or may be machined to non-standard dimensions.

More aspects of the balancing weights 30 and how the rotor 21 and the balancing weights 30 may be assembled and may interconnect will be described later. Suffice it to say with respect to FIG. 2 that the rotor 21 has holes 24 for interconnection of the balancing weights 30 with the rotor 21. The balancing weight 30 is removably secured to the rotor 21 through engagement into a hole 24. The bore 23 or interior of the rotor 21 may define limited access areas as a consequence of the bore 23 size and/or due to the elongated nature of the rotor 21. Manipulation of the balancing weights 30 during installation in the rotor assembly 20, or disassembly therefrom, for balancing the rotor, may thus be troublesome in various cases.

Rotor balancing is about removing or reducing rotor eccentricities. These eccentricities cause vibration in the engine 10 as a whole, but have little to no effect on the natural frequency of the rotor 21. The purpose of weight balancing a rotor 21 is to align the actual rotor axis R-R (i.e. its inertial axis) to the physical centerline of the rotor 21. The misalignment in the actual versus desired axis causes an imbalance. This imbalance manifests itself as a vibration which occurs with each revolution of the rotor 21. Reducing these vibrations is not considered, by those skilled in the art, to be the same as tuning the rotor 21. In particular, the purpose of tuning a rotor 21 is to adjust the natural frequency of the rotor 21, so that natural frequencies may be outside of a predetermined range frequencies. This may reduce, for instance, the likelihood that the rotor 21 will resonate, thereby reducing the vibratory stress experienced by the rotor 21. Stated differently, one objective in balancing a rotor 21 is to align the actual axis of rotation with the desired axis of rotation, whereas the goal of tuning a rotor 21 is to adjust its natural frequency.

The balancing weights 30 herein disclosed may thus be disposed about the central axis of the rotor 21 to correct a rotational imbalance of the rotor assembly 20. Such rotational imbalance may be observed using known techniques, therefore this will not be further described. As a result of the observation, a magnitude of imbalance caused by an eccentric rotating mass which is a function of the weight of the eccentric rotating mass and the radial distance of said mass from an axis of rotation, may be determined. The angular direction of imbalance may also be determined by the angular position of the eccentric mass relative to an arbitrary reference angular direction. The magnitude and angular direction of imbalance may be determined in a radial plane normal to the rotation axis R-R, which may correspond to the central axis 11 of the engine 10 in some embodiments.

The balancing weights 30 may have different masses and at least one or more balancing weights 30 may be attached to the rotor 21 at selected locations about the rotation axis R-R. The number of balancing weights 30 required to balance the rotor assembly 20 may vary depending on the application and/or rotor imbalance. Different masses for the individual balancing weights 30 may be achieved by varying the dimension(s), material(s), shape(s) and/or geometry(ies) of the balancing weights, for instance.

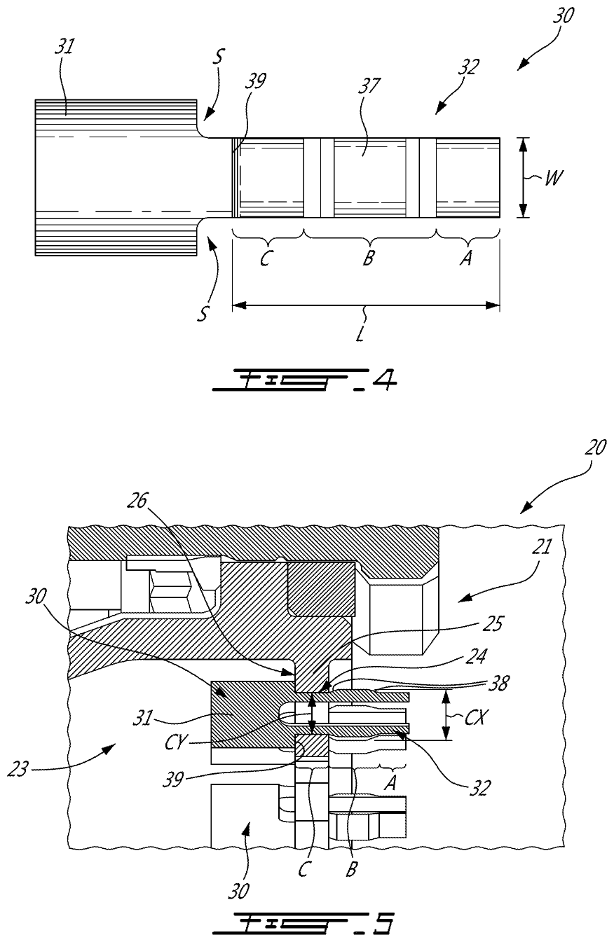

Referring to FIGS. 3-4, a balancing weight 30 is shown, according to one embodiment. A portion of the wall 25 of the rotor 21 with the hole 24 is also shown. The balancing weight 30 comprises a head 31 having a predetermined weight. The head 31 accounts for a majority of the overall mass of the balancing weight 30. Varying the dimension(s), material(s), shape(s) and/or geometry(ies) of the head 31 of the balancing weights 30 may thus allow to adjust the mass of a given balancing weight 30.

The head 31 may have any polygonal shape (shape or cross-section), varying or constant, depending on balancing and assembly requirements. For instance, in the depicted embodiment, the head 31 has a cylindrical shape, but other shapes may be contemplated, such as, without limitation, rectangular, hexagonal, etc.

The balancing weight 30 comprises a shank 32 (shank or “pin”) extending axially from the head 31. The relative size of the head 31 and the shank 32 may be different depending on the embodiments. For instance, a ratio of the length L of the shank 32 over the largest radial dimension (e.g. largest diameter in cases where the head has generally disc or round shape, for instance) may be different—the shank 32 may be longer or shorter, and the head 31 may alternately or additionally have a greater or smaller cross-sectional dimension.

The shank 32 is resilient, such that under normal use conditions, it may be compressed or expanded and may recover its initial shape reversibly (without substantial hysteresis). This may result from the material of the shank 32, but the overall geometry of the shank 32 may also contribute to such resilience. The shank 32 is radially expandable/contractable (expandable/contractable or compressible transversally to its length L) between a first position, which may also be referred to as a compressed position or compressed state in some embodiments, in which a cross-sectional dimension CX of the shank 32 is less than the predetermined cross-sectional dimension CY of the hole(s) 24, and a second position, which may also be referred to as a expanded position or uncompressed state, in which the cross-sectional dimension CX of the shank 32 is greater than the predetermined cross-sectional dimension CY of the hole 24 in the rotor 21. What corresponds to the cross-sectional dimension CX of the shank 32 is illustrated at FIG. 3A and described below. Characteristics of the first position and the second position will be described below.

An axially extending slot 33 is formed in the shank 32. In other words, the slot 33 defines an elongated gap extending along at least part of the length L of the shank 32 from a distal end 34 thereof. In the depicted embodiment, the slot 33 extends from a distal end 34 of the shank 32 to the head 31. The slot 33 may extend in the head 31 in some embodiments, depending on the geometry of the head 31 and/or respective geometries of the head 31 and shank 32 where they mate.

The slot 33 defines two axially extending portions 32A, 32B of the shank 32, but the slot 33 may define more axially extending portions in other embodiments. In other words, although the shank 32 in the depicted embodiment defines a pair of laterally spaced apart portions extending along the length L of the shank 32, the shank 32 may define more or less spaced apart portions in other embodiments. For instance, in an embodiment, the shank 32 may define a single elongated portion. In such case, the single elongated portion may or may not have a hollow body, and the single elongated portion may have a slot 33 extending over at least part of the length L of the shank 32 to allow deformation of the single elongated portion upon compression. In other embodiments, the shank 32 may define three, four, five, or more than five axially extending portions separated from each other along their length by a gap (or simply “slot 33”) to allow radial deformation of the axially extending portions, which may deflect toward a central axis Z of the shank 32.

In the depicted embodiment, the at least two axially extending portions 32A, 32B of the shank 32 each define a cantilevered arm. The cantilevered arms extend from a proximal portion 35 of the shank 32, i.e. the end of the shank 32 that connects to the head 31, to the distal end 34 of the shank 32. Regardless of the number of cantilevered arms, the cross-sectional dimension CX of the shank 32 corresponds to the combined cross-sectional dimension of each cantilevered arms when viewed from the distal end 34 of the shank 32, and includes the cross-sectional area defined by the slot 33. This is illustrated in FIG. 3A. In other words, the equivalent plane of the cross-sectional area of the slot 33 combined with the cross-sectional dimension of the cantilevered arms, all of which defining the cross-sectional dimension of the shank 32.

In the depicted embodiment, the cantilevered arms extends parallel to one another along the length L of the shank 32. As another possibility, the cantilevered arms may extend at angle from one another, in other words in unparalleled directions when the shank is in the rest position. The cantilevered arms may extends straight or extend, at least partially, in a curvilinear direction in various embodiments.

In a particular embodiment, such as shown, the shank 32 has two cantilevered arms. The slot 33 extends along the length L of the shank 32, between the cantilevered arms, and defines opposite surfaces 36 of the cantilevered arms, with the opposite surfaces facing each other. The cantilevered connection between the shank portions (in the depicted embodiment, the cantilevered arms), which contributes to the resiliency of the shank 32, allows for the cantilevered arms to deflect, such that their respective distal end 34 may be closer from each other in the first position than in the second position of the shank 32. In some cases, the cantilevered arms may deflect toward each other until contacting each other, although this is only one possibility. Other characteristics of the shank 32 may affect the rigidity (rigidity or resiliency) of the shank 32. with the cross-sectional dimension of the shank portion (or cantilevered arm) along the length L of the shank 32, which can be referred to as the “thickness” or transverse dimension of the shank portion, as one possibility.

The balancing weight 30 has self-retaining features that allows for the balancing weight 30 to be axially secured within the hole 24 when the shank 32 is in the second position and removably engaged in the hole 24. As balancing weight 30 typically do not experience significant axial loads during operating conditions of the rotor assembly 20 and engine 10, such self-retaining features may allow for tool less installation/disassembly, for instance by simple push/pull force exerted by a user, without the need for additional fasteners or locking features, such as nuts, screws, lock nuts, washers, adhesive, etc. For instance, the balancing weight 30 is configured such that pushing/pulling loads to engage/disengage the balancing weight 30 in/from a hole 24 of the rotor 21 allows for quick installation by a user, while still providing axial retention load to retain the balancing weight 30 safely secured in the rotor 21 during normal operating conditions of the rotor 21 in the engine 10. Exemplary self-retaining features part of the shank 32 are discussed herein.

In some embodiments, at least one of the cantilevered arms has a cross-sectional dimension CX1 that varies between the proximal portion 35 and the distal end 34 of the shank 32. In the depicted embodiment, both cantilevered arms (which correspond to all of the cantilevered arms in this embodiment) have a respective cross-sectional dimension CX1, CX2 that vary between the proximal portion 35 and the distal end 34 of the shank 32. The cantilevered arms each define a bulge 37 at an outer periphery thereof. As a consequence of the bulge 37, the cross-sectional dimension CX of the shank 32 at the bulge 37 may be larger than at any other location along the remainder of the shank 32.

While the bulges 37 are axially aligned with one another along the cantilevered arms, this may be different in other embodiments. The cantilevered arms, shown with an identical geometry, including identical bulge 37 geometry, may differ (slightly or substantially differ) depending on the embodiments. As one possibility discussed above, only one of the cantilevered arms may have a bulge 37 (or other similar self-retaining features).

In the depicted embodiment, the bulge 37 increases progressively in thickness such that the cantilevered arms has a cross-sectional dimension CX1, CX2 that progressively increases along the length L of the shank 32 to reach a maximal cross-sectional dimension at an axial location corresponding to the bulge 37, and then progressively decreases from said maximal cross-sectional dimension. Stated differently, the bulge 37 has opposite axial ends 38 that are shaped such as to progressively reduce the cross-sectional dimension CX of the shank 32 axially therealong. In a particular embodiment, the opposite axial ends 38 of the bulge 37 are sloped (sloped or chamfered). Other configurations may be contemplated, such as rounded axial ends 38 (concave or convex) defining concave or convex surfaces forming part of the outer periphery of the shank 32 (or outer periphery of the cantilevered arms).

While both axial ends 38 of the bulge 37 are configured identically in the depicted embodiment, this may be different in other embodiments. For instance, one axial end 38 may be more or less sloped than the other. In other words, the cross-sectional dimension CX of the shank 32 may decrease more or less progressively on one axial end 38 of the bulge 37 than on the other, for instance.

In the depicted embodiment, the bulge 37 of each cantilever arm extends over the full width W of the cantilever arm. The bulge 37, either on one or more of the cantilevered arms may extend transversally over only a fraction of the width W of the cantilever arm, as other possible configurations.

The bulge 37 allows for axially retaining the shank 32 in the hole 24 of the rotor 21 when the shank 32 is engaged therein and in the second position. Having bulge(s) 37 with axial ends 38 as discussed above may allow for an easier (“smoother”) engagement of the shank 32 in the hole 24 than without these axial ends 38 configurations discussed above, while still allowing for axially securing the shank 32 in the hole 24 once installed on the rotor 21, as will be discussed below.

With continued reference to FIGS. 3 and 4, the bulge 37 is located at a distance X from the distal end 34 of the shank 32. Depending on the embodiments, the bulge 37 may be closer or further away from the distal end 34 of the shank 32. In the depicted embodiment, the shank 32 has a first portion A extending from the distal end 34 of the shank 32 to an axial end 38 of the bulge 37. Such first portion A has a constant (or substantially constant) cross-sectional dimension CX. The cross-sectional dimension CX of the shank 32 along such first portion A is smaller than at an adjacent second portion B, which in this embodiment corresponds to the portion of the shank 32 that includes the bulges 37. The shank 32 has at least a third portion C extending between the second portion B (the bulges 37) and the head 31 of the balancing weight 30. Such third portion C of the shank 32 may have a cross-sectional dimension CX that corresponds to that of the first portion A, though other dimensions are possible.

Referring to FIG. 5, a magnified view of the rotor assembly 20 shown in FIG. 2, showing balancing weights 30 installed on the rotor 21. The balancing weights 30 are removably secured to the rotor assembly 20. As shown, the balancing weights 30 are connected to a flange 26 of the rotor 21 depending from the annular wall 25 of the rotor 21, within the bore 23 of the rotor 21.

When the shank 32 is being engaged through a hole 24 of the rotor 21, the first portion A (the distalmost portion) of the shank 32 may engage the hole 24 without compression (without compression or without substantial compression), or stated differently, without deflection (without deflection or without substantial deflection) of the shank 32. In other words, in the depicted embodiment, the shank 32, at the first portion A thereof, in the first position, which may also be referred to as an unbiased or uncompressed state, has a cross-sectional dimension CX that correspond to the cross-sectional dimension CY of the hole 24.

While the shank 32 is being inserted further into the hole 24, the second portion B of the shank 32 may contact the hole 24 opening. In the depicted embodiment, this corresponds to a position of the shank 32 where one of the axial ends 38 of the bulges 37 may contact the hole 24 opening. At this point, by applying an axial force on the balancing weight 30 so-being inserted in the hole 24, the shank 32 may compress/deflect (or progressively compress/deflect) as a consequence of the shank 32 having a cross-sectional dimension CX at the second portion B of the shank 32 that progressively increase until reaching a dimension greater than the predetermined cross-sectional dimension CY of the hole 24. As such, in the depicted embodiment in which there is a plurality of axially extending cantilevered arms extending from the head 31, as discussed above, compressing the shank 32 during insertion of the shank 32 through the hole 24 includes deflecting the plurality of axially extending cantilevered arms toward each other.

The compression load exerted on the outer periphery of the shank 32 upon axially forcing the shank 32 through the hole 24, more particularly in the depicted embodiment the bulges 37 of the shank 32, causes a reduction of the overall cross-sectional dimension CX of the shank 32, which may then be referred to as in a compressed state. When the shank 32 is being inserted even further in the hole 24, the second portion B, in the depicted embodiment corresponding to the bulges 37, may be released from compression load (or radial contact with the inside periphery of the hole 24) when such second portion B reaches the other side of the wall 25 of the rotor 21, as shown in FIG. 5. While this happens, the shank 32 snaps back (or “clinches back”) to a self-retaining state, which in turn increases the cross-sectional dimension CX of the shank 32 at the second portion B to more than the predetermined cross-sectional dimension CY of the hole 24 in which the shank 32 is inserted. In this position, a distal portion of the shank 32, that is the first and second portions A, B of the shank 32, hangs out from the hole 24, while the third portion C of the shank 32 remains in the hole 24. In other words, the wall 25 is thus located between the bulges 37 and the head 31 of the balancing weight 30. In a particular embodiment, the fraction of the length L of the shank 32 that extends from the head 31 of the balancing weight 30 to the bulge(s) 37 is selected such as to correspond to the thickness T of the wall 25.

With further reference to FIG. 5, the head 31 has opposite axial ends 39, with one end 39 defining an abutting surface at a junction between the shank 32 and the head 31 (where they mate or merge together). Such abutting surface may abut against the rotor 21 when the balancing weight 30 is in the second position and engage in the hole 24. Such axial end 39 may act as an axial stopper preventing further axial engagement of the shank 32 in the hole 24.

To remove the shank 32 from the hole 24, for disassembly of the balancing weight 30 from the hole 24, for instance, the above operations may be reversed. Referring back to FIGS. 3 and 4, the head 31 has an outer periphery extending between the opposite axial ends 39 of the head 31. The outer periphery of the head 31 defines a shoulder S at the axial end 39 of the head 31 proximate the shank 32. The shoulder S extends from the axial end 39 of the head 31 proximate the shank toward the opposite axial end 39 of the head 31. As shown, the shoulder S defines a concave peripheral surface in the head 31.

Such shoulder S may facilitate disassembly of the balancing weight 30 from the hole 24 once inserted therein. Notably, such shoulder S may define a clearance between the head 31 and the wall 25 of the rotor 21 once the balancing weight 30 is engaged thereto. As such, one may more easily grab or pinch the balancing weight 20 to pull the balancing weight 30 out from the hole 24 via a pull force exerted on the head 31. While in the depicted embodiment there is shown a pair of axisymmetric shoulder S, there may be more or less shoulder(s) S in other embodiments. Such shoulder(s) S may also be absent in some embodiments.

In the depicted embodiment, the head 31 and the shank 32 form a single part. In other words, the head 31 and the shank 32 are formed as an integral or unitary piece. For instance, in some embodiments, the head 31 and the shank 32 may be machined as a single part using any suitable material removal manufacturing techniques, such as machining, and/or using any suitable additive manufacturing techniques, such as 3D printing, for instance.

The shank 32 having such self-retaining feature(s) at an outer periphery thereof may thus allow for inserting the shank 32 of the balancing weight 30 through the hole 24 from one side of the wall 25 to the other side of the wall 25, without having access to the other side of said wall 25, for instance. The presence of the self-retaining features, which may also be defined as self-clinching features, may contribute to axial retention of the balancing weight 30 to the rotor 21 once inserted in through the hole 24. The rigidity opposing to the compression (compression or radial contraction) of the shank 32, or deflection of the cantilevered arms of the shank 32 may also contribute to the level of force required to push or pull the shank 32 through the hole 24 and in thus the level of force required to install or disassemble the balancing to/from the rotor 21 through the rotor hole 24.

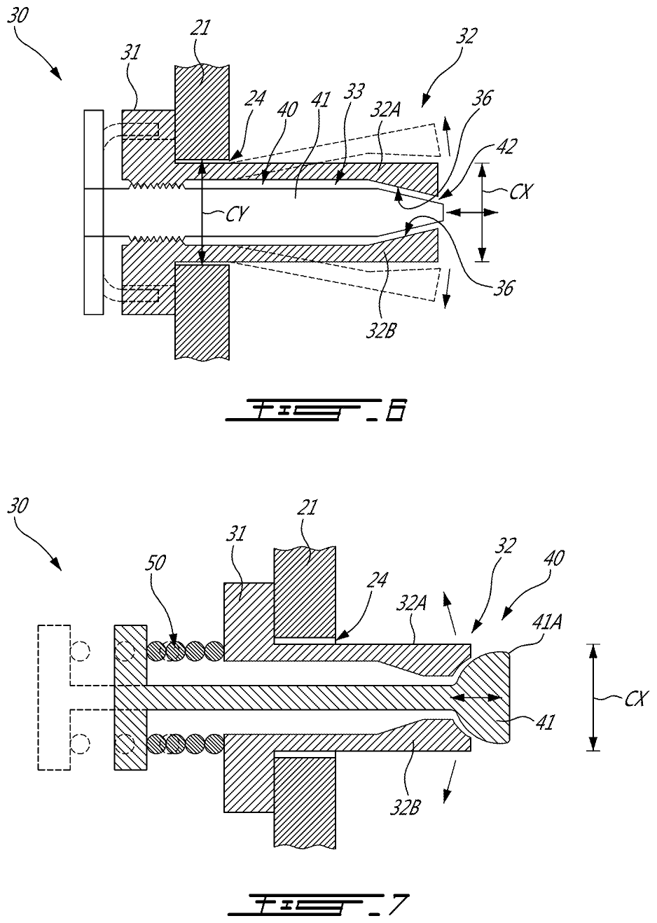

Referring to FIGS. 6 to 10, there are shown various other embodiments of the balancing weight 30 with self-retaining features, such as discussed above.

Referring to FIG. 6, the balancing weight 30 has a head 31 and a shank 32 extending axially from the head 31. In the depicted embodiment, the shank 32 defines at least two portions 32A, 32B that are contractable/expandable in a direction transverse to the hole engagement direction (see opposite arrows at the distal end of the shank 32 on FIG. 6). The two portions 32A, 32B are radially expandable (expandable or contractable) between a first position in which the cross-sectional dimension CX of the shank 32 is greater than the predetermined cross-sectional dimension CY of the hole 24 (see position of portion 32B in dotted lines in FIG. 6) and a second position in which the cross-sectional dimension CX of the shank 32 is less than the predetermined cross-sectional dimension of the hole 24 in the rotor 21, as similarly discussed above with respect to other embodiments. As shown, the two portions 32A, 32B extend axially from the head 31 and each define a cantilevered arm. The two portions 32A, 32B are separated by a slot 33.

In this embodiment, the self-retaining features of the balancing weight 30 is in the form of a plunger mechanism 40. In this embodiment, upon activation of the plunger mechanism 40, the shank 32 may change of shape. More particularly, the shank 32 expand or contract radially to change of cross-sectional dimension CX. The shank 32 includes a plunger 41 extending axially from the head 31 within the slot 33, between the two portions 32A, 32B of the shank 32. The plunger 41 may move axially relative to the two portions 32A, 32B and/or the head 31. In the depicted embodiment, the plunger 41 is connected to the head 31 via a threaded engagement in the head 31. The plunger 41 and the head 31 have corresponding threads such that the plunger 41 may move axially within the slot 33 when the plunger 41 is being screwed or unscrewed. The plunger 41 has a beveled distal end 42 for engaging a correspondingly shaped surfaces of the two portions 32A, 32B. Said correspondingly shaped surfaces may correspond to the opposite surfaces 36 discussed above with respect to other embodiments. During operation of the plunger mechanism 40, the plunger 41 may move axially along the two portions 32A, 32B and engage the correspondingly shaped surfaces of the two portions 32A, 32B, such as to force the two portions to deflect radially away from each other. In other words, the plunger 41 progressively splits the two portions 32A, 32B apart to increase the cross-sectional dimension CX of the shank 32, which provides axial retention of the balancing weight 30 in the hole 24.

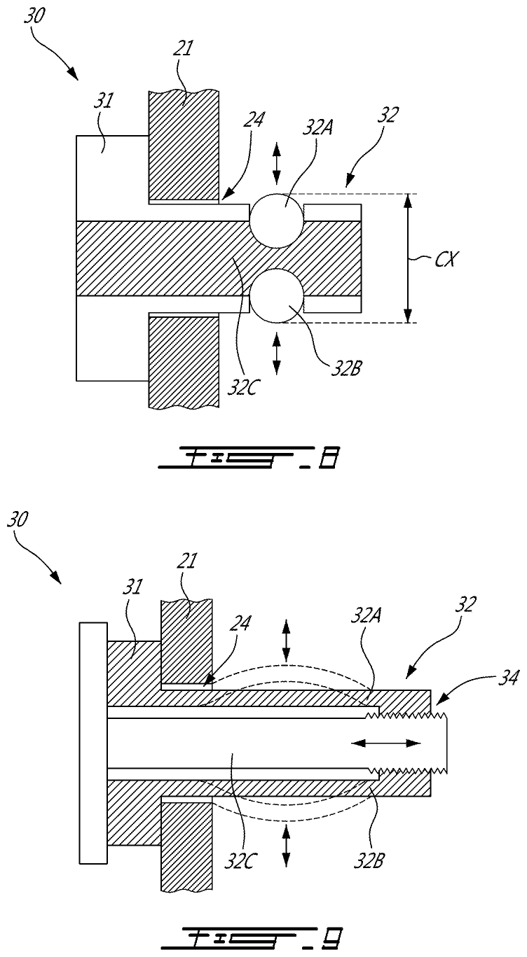

Referring to FIG. 7, a balancing weight 30 with a similar plunger mechanism 40 as discussed above is shown. In the depicted embodiment, the plunger 41 is axially biased in a position in which the two portions 32A, 32B are radially deflected away from each other. The plunger 41 extends through the head 31 and is connected to the head 31 at least via a biasing member 50, which is a spring in this case. The plunger 41 defines a plunger head 41A at a distal end thereof. The plunger head engage opposite beveled surfaces of the two portions 32A, 32B. Upon activation of the plunger mechanism 40, the biasing member 50 is compressed, which in turn axially disengages the plunger head 41A from the opposite beveled surfaces of the two portions 32A, 32B (disengage and/or release the force exerted radially outwardly on the two portions 32A, 32B). This position is shown in FIG. 7. As such, the cross-sectional dimension CX of the shank 32 reduces to allow the shank 32 to engage the hole 24 in the rotor 21. When the biasing member is released (see shadow or dotted lines in FIG. 7), the plunger 41 moves axially relative to the two portions 32A, 32B and the plunger head 41A engages the two portions 32A, 32B to deflect the two portions 32A, 32B away from each other, such as to increase the cross-sectional dimension CX of the shank 32. Consequently, the cross-sectional dimension CX of the shank 32 becomes larger than the cross-sectional dimension CY of the hole 24, which allow axial retention of the balancing weight 30 to the rotor 21.

Referring to FIG. 8, a balancing weight 30 with other exemplary self-retaining features is shown. In the depicted embodiment, the shank 32 includes two portions 32A, 32B, here in the form of retractable pins or balls, that may move relative to each other in a direction transverse to the hole engagement direction. The shank 32 has a deformable core 32C, with at least a portion of said deformable core 32C located between the retracting pins/balls. The deformable core 32C biases radially outwardly the pins/balls. When the shank 32 is being pushed in the hole 24, the retractable pins/balls move towards each other, thereby reducing the cross-sectional dimension CX of the shank 32. Once the outwardly biased retractable pins/balls come out of the hole 24, said pins/balls spring back (spring back or snap back) into place, whereby the cross-sectional dimension CX of the shank 32 increases to a dimension greater than the cross-sectional dimension CY of the hole 24. When the shank 32 is so engaged in the hole 24, as shown in FIG. 8, the retractable pins/balls allow for axial retention of the shank 32 within the hole 24. The rigidity of the deformable core of the shank 32 may oppose a force exerted on the pins/balls to radially outwardly bias said pins/balls.

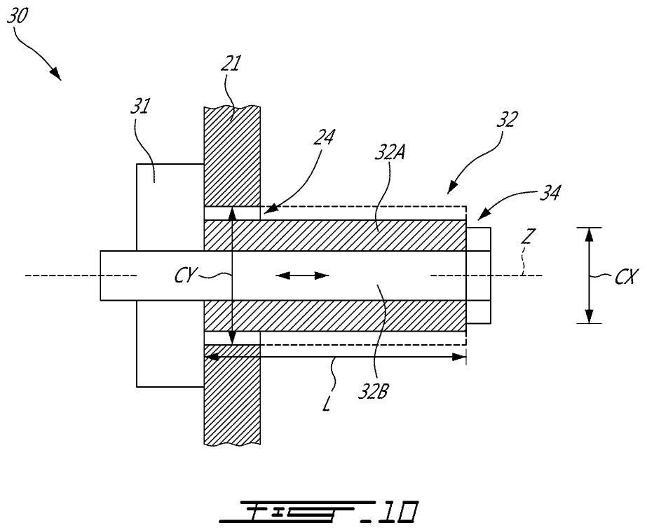

Referring to FIG. 9, another exemplary balancing weight 30 with other self-retaining features is shown. In the depicted embodiment, the shank 32 includes a third portion 32C extending axially between portions 32A, 32B. The third portion 32C defines a screw rotatably engaged through the head 31 and extending along he two portions 32A, 32B along a central axis of the shank 32. The screw has threads at least at a distal end thereof. In the depicted embodiment, the shank 32 has two portions 32A, 32B each having threads at their distal ends for engagement with the threads of the screw. Such threaded connection engages the distal ends of portions 32A, 32B with the screw. Once the shank 32 is installed in the hole 24, the screw may be rotated to apply an axial load (here an axial compression load on the portions 32A, 32B of the shank 32). The axial load exerted on the two portions 32A, 32B from the screw screwing in causes the two portions 32A, 32B to bulge outwardly (bulge outwardly or bow laterally), which consequently increases the cross-sectional dimension CX of the shank 32 (see dotted lines on FIG. 9 showing the bowed configuration of the two portions 32A, 32B of the shank 32). In this configuration, the self-retaining features plays its role, similar to that discussed above with respect to other embodiments.

Referring to FIG. 10, a further exemplary balancing weight 30 with self-retaining features is shown. In the depicted embodiment, the shank 32 includes a first portion 32A made of an elastomeric material and a second portion 32B extending along the central axis Z of the shank 32. In the depicted embodiment, the elastomeric portion defines an outer periphery of the shank 32. The elastomeric portion extends axially from the head 31 to a distal end 34 thereof. The distal end 34 of the elastomeric portion is connected (in this case bonded) to a distal end 34 of the second portion 32B. The second portion 32B is in the form of a pin extending through the head 31 of the balancing weight 30, along the length L of the shank 32. The pin (or second portion) has an axial end that sticks out from the head 31. By pushing on said axial end, the shank 32 elongates and depressed to reduce the cross-sectional dimension CX of the shank 32 due to the elastomeric deformation of the first portion, as a consequence of the Poisson effect of the material. As such, when a push force is applied on the pin (second portion of the shank 32), the shank 32 may engage the hole 24 of the rotor 21. Once installed, the pin may be released (the push force may be released), which in turn shortens toe shank 32 to its original length L, whereby the original cross-sectional dimension CX in the first position is restored to form an interference fit between the outer periphery of the shank 32 and the hole 24. In this position, the balancing weight 30 may be self-retained to the rotor 21 (see configuration illustrated in dotted lines in FIG. 10). The above description is meant to be exemplary only, and one skilled in the art will recognize that changes may be made to the embodiments described without departing from the scope of the invention disclosed. For example, the described apparatus and method may be applicable to rotors in a gas turbine engine different from the described and illustrated turbofan engine, and the rotor assembly, including the rotor, shaft(s) enclosure(s) shapes and size, and/or interface(s) between components of the rotor assembly may be configured differently from that described and shown in the depicted embodiments.

For instance, instead of a hole 24 in a wall 25 of the rotor 21 that extends across the wall 25, i.e. from one side to another side of the wall 25, the hole 24 may have a finite depth (not entirely across the wall 25), or the hole 24 may be shaped such as not to allow the shank 32 of the balancing weight 30 to hang out from one side of the hole 24 when the balancing weight 30 is installed to the rotor 21.

Still other modifications which fall within the scope of the described subject matter will be apparent to those skilled in the art, in light of a review of this disclosure, and such modifications are intended to fall within the appended claims.

1. A balancing weight engageable in a hole defined in a rotor, the hole having a predetermined cross-sectional dimension, the balancing weight comprising:
a head having a predetermined weight, and
a shank extending axially from the head, the shank including at least two portions expandable in a direction transverse to a hole engagement direction between a first position in which a cross-sectional dimension of the shank is less than the predetermined cross-sectional dimension of the hole and a second position in which the cross-sectional dimension of the shank is greater than the predetermined cross-sectional dimension of the hole in the rotor.

2. The balancing weight as defined in claim 1, wherein the shank includes an axially extending slot formed therein and defining the at least two portions of the shank.

3. The balancing weight as defined in claim 2, wherein the at least two portions of the shank each define a cantilevered arm, the cantilevered arms extending from a proximal portion of the shank connected to the head to a distal end of the shank.

4. The balancing weight as defined in claim 2, wherein the slot extends from a distal end of the shank to the head.

5. The balancing weight as defined in claim 4, wherein the slot extends in the head.

6. The balancing weight as defined in claim 3, wherein the shank defines a pair of cantilevered arms, the slot extending axially between the pair of cantilevered arms and defining opposite surfaces of the cantilevered arms, the opposite surfaces facing toward each other.

7. The balancing weight as defined in claim 3, wherein at least one of the cantilevered arms has a cross-sectional dimension that varies between the proximal portion and the distal end of the shank.

8. The balancing weight as defined in claim 3, wherein the cantilevered arms each have a distal end, their distal ends being closer from each other in the first position than in the second position.

9. The balancing weight as defined in claim 3, wherein the cantilevered arms define respective bulges at an outer periphery thereof, the bulges being axially aligned along the cantilevered arms.

10. The balancing weight as defined in claim 2, wherein at least one of the axially extending portions defines a bulge at an outer periphery thereof, the cross-sectional dimension of the shank being larger than the remainder of the shank at the bulge, as a consequence of the bulge.

11. The balancing weight as defined in claim 10, wherein the bulge has opposite axial ends, the opposite axial ends being configured to progressively reduce the cross-sectional dimension of the shank axially therealong.

12. The balancing weight as defined in claim 11, wherein the opposite axial ends of the bulge are sloped.

13. The balancing weight as defined in claim 2, wherein the head has an outer periphery extending between opposite axial ends of the head, the outer periphery defining a shoulder at the axial end of the head proximate the shank, the shoulder extending from the axial end of the head proximate the shank toward the opposite axial end of the head and defining a concave peripheral surface in the head.

14. The balancing weight as defined in claim 2, wherein the head has opposite axial ends, one of the axial ends defining an abutting surface at a junction between the shank and the head, the abutting surface configured to abut against the rotor when the balancing weight is in the first position and engaged in the hole.

15. The balancing weight as defined in claim 2, wherein the head and the shank are made as a unitary piece.

16. A rotor assembly of a gas turbine engine, the rotor assembly comprising:
a rotor mounted to the gas turbine engine for rotation about a rotation axis, the rotor having a wall and defining at least one hole through said wall, the at least one hole having a predetermined cross-sectional dimension; and
a balancing weight engaged through the hole, the balancing weight removably secured to the rotor through engagement into the hole, the balancing weight including:
a head having a predetermined weight;
a shank extending axially from the head, the shank having at least two portions expandable in a direction transverse to a hole engagement direction between a first position in which a cross-sectional dimension of the shank is less than the predetermined cross-sectional dimension of the hole and a second position in which the cross-sectional dimension of the shank is greater than the predetermined cross-sectional dimension of the hole in the rotor.

17. The rotor assembly as defined in claim 16, wherein the at least two axially extending portions of the shank each define a cantilevered arm, the cantilevered arms extending from a proximal portion of the shank connected to the head to the distal end of the shank, the cantilevered arms being separated by a gap to allow deflection of the cantilevered arms relative to each other.

18. A method for installing a balancing weight on a rotor, the rotor defining a wall, a hole defined in the wall, the balancing weight including a head having a predetermined weight and a shank extending axially from the head, the method comprising:
inserting the shank of the balancing weight in the hole in the wall, and
radially expanding the shank in the hole until the shank adopts a self-retaining state, the cross-sectional dimension of the shank in the self-retaining state being greater than the cross-sectional dimension of the hole.

19. The method as defined in claim 18, wherein inserting the shank includes contracting the shank during insertion of the shank in the hole, which causes a reduction of a cross-sectional dimension of the shank in a contracted state wherein the cross-sectional dimension of the shank become smaller than the cross-sectional dimension of the hole.

20. The method as defined in claim 19, wherein the shank defines a plurality of cantilevered arms extending from the head, wherein contracting the shank during insertion of the shank through the hole includes deflecting the plurality of cantilevered arms toward each other.

21. The method as defined in claim 18, wherein the head has an axial end proximate the shank, wherein inserting further the shank in the hole includes abutting the axial end against the wall of the rotor when the balancing weight is in the self-retaining state and engaged in the hole.

22. A method for engaging a balancing weight in a hole defined in an engine rotor, the hole having a cross-sectional dimension, the balancing weight having a head having a predetermined weight and a shank extending axially from the head, the method comprising:
inserting the shank through an opening of the hole;
driving the shank in the hole to a first axial position, including contracting the shank, thereby reducing a cross-sectional dimension of the shank in a compressed state, the cross-sectional dimension of the shank in the compressed state being smaller than the cross-sectional dimension of the hole opening; and
driving further the shank in the hole from the first axial position to a second axial position, wherein in the second axial position the cross-sectional dimension of the shank increases to a dimension larger than the cross-sectional dimension of the hole opening.
